(19) United States
(12) Patent Application Publication
(10) Pub. No.: US 2025/0138942 A1
(43) Pub. Date: May 1, 2025

(54) STORAGE DEVICE, MEDIA INTERFACE DEVICE OF THE STORAGE DEVICE, AND OPERATING METHOD OF THE MEDIA INTERFACE DEVICE

(71) Applicant: SAMSUNG ELECTRONICS CO., LTD., Suwon-si (KR)

(72) Inventors: Hanju LEE, Suwon-si (KR); Kyungryun KIM, Suwon-si (KR)

(73) Assignee: SAMSUNG ELECTRONICS CO., LTD., Suwon-si (KR)

(21) Appl. No.: 18/930,513

(22) Filed: Oct. 29, 2024

(30) Foreign Application Priority Data
Oct. 30, 2023 (KR) 10-2023-014752

(51) Int. Cl. G06F 11/10; G06F 21/79

(52) U.S. Cl. CPC G06F 11/1016; G06F 11/1068; G06F 21/79

(57) ABSTRACT

Provided is a storage device including a plurality of non-volatile memory devices, a host interface device configured to communicate with an external host device through an interface channel, and at least one media interface device connected between the host interface device and the plurality of non-volatile memory devices, the at least one media interface being configured to control the plurality of non-volatile memory devices, wherein the at least one media interface device is further configured to perform an operation offloaded from the host interface device and perform serial communication with the host interface device.

### CROSS-REFERENCE TO THE RELATED APPLICATION

This application claims priority to Korean Patent Application No. 10-2023-0147152, filed on Oct. 30, 2023, in the Korean Intellectual Property Office, the disclosure of which is incorporated by reference herein in its entirety.

### BACKGROUND

Embodiments relate to a memory device, and more particularly, to a storage device, a media interface device of the storage device, and an operating method of the media interface device.

Semiconductor memories are classified as volatile memory devices, such as static random access memory (SRAM) and dynamic random access memory (DRAM), which lose stored data when power supply is cut off, and nonvolatile memory devices, such as flash memory devices, phase-change random access memory (PRAM), magnetoresistive random access memory (MRAM), resistive random access memory (RRAM), and ferroelectric random access memory (FRAM), which retain stored data even when power supply is cut off. A storage controller of the storage device may include a media interface having a multi-channel structure, and as semiconductors become more integrated and miniaturized, pad limitations may occur.

### SUMMARY

One or more embodiments provide a media interface device in which some functions of a storage controller are offloaded, an operating method of the media interface device, and a storage device including the media interface device.

According to an aspect of an embodiment, there is provided a storage device including a plurality of non-volatile memory devices, a host interface device configured to communicate with an external host device through an interface channel, and at least one media interface device connected between the host interface device and the plurality of non-volatile memory devices, the at least one media interface being configured to control the plurality of non-volatile memory devices, wherein the at least one media interface device is further configured to perform an operation offloaded from the host interface device and perform serial communication with the host interface device.

According to another aspect of an embodiment, there is provided a system including a plurality of non-volatile memory devices, and a media interface device including a first interface circuit configured to connect to an external host interface device to operate as a storage device, a second interface circuit configured to connect to the plurality of non-volatile memory devices, and a processing circuit configured to perform an operation offloaded from the host interface device, wherein the first interface circuit is further configured to perform serial communication with the host interface device.

According to still another aspect of an embodiment, there is provided an operating method of a media interface device connected between a host interface device configured to communicate with an external host device and a plurality of non-volatile memory devices and configured to control the plurality of non-volatile memory devices, the operating method including receiving, from the host interface device, a first command in which a plurality of host commands of the external host device are serialized, deserializing the first command to generate a plurality of second commands, performing operation an operation offloaded from the host interface device on the plurality of second commands to generate a plurality of third commands, and transmitting the plurality of third commands to the plurality of non-volatile memory devices, respectively.

### BRIEF DESCRIPTION OF DRAWINGS

Embodiments will be more clearly understood from the following detailed description taken in conjunction with the accompanying drawings in which:

FIG. 1 is a block diagram illustrating a host-storage system according to an embodiment;

FIG. 2 is a block diagram illustrating a host-storage system according to a related example;

FIG. 3 is a block diagram illustrating a substrate of a storage controller according to a related example;

FIG. 4 is a block diagram illustrating a substrate of a storage device according to a related example;

FIG. 5 is a block diagram illustrating a substrate of a storage device according to an embodiment;

FIG. 6 is a detailed block diagram illustrating the host-storage system of FIG. 1;

FIG. 7 is a block diagram illustrating SerDes according to an embodiment;

FIG. 8A is a detailed block diagram illustrating an error correction code (ECC) engine of FIG. 6;

FIG. 8B is a detailed block diagram illustrating an advanced encryption standard (AES) engine of FIG. 6;

FIG. 9 is a block diagram illustrating a memory device according to an embodiment;

FIG. 10 is a flowchart illustrating an operating method of a host-storage system according to an embodiment;

FIG. 11 is a flowchart illustrating an operating method of a media interface device according to an embodiment;

FIGS. 12A and 12B are block diagrams illustrating a packaging form of a media interface device according to an embodiment;

FIG. 13 is a block diagram illustrating a system including a storage device according to an embodiment;

FIG. 14 is a block diagram illustrating a data center including a storage device according to an embodiment; and

FIG. 15 is a cross-sectional view illustrating a BVNAND structure applicable to a storage device according to an embodiment.

### DETAILED DESCRIPTION

Hereinafter, embodiments are described in detail with reference to the attached drawings. Embodiments described herein are example embodiments, and thus, the disclosure is not limited thereto.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

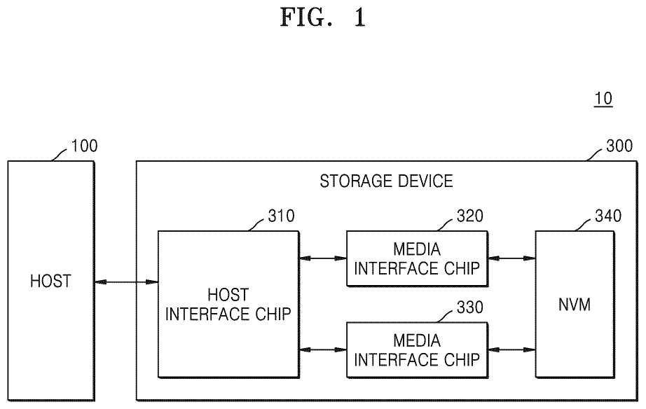

FIG. 1 is a block diagram illustrating a host-storage system 10 according to an embodiment.

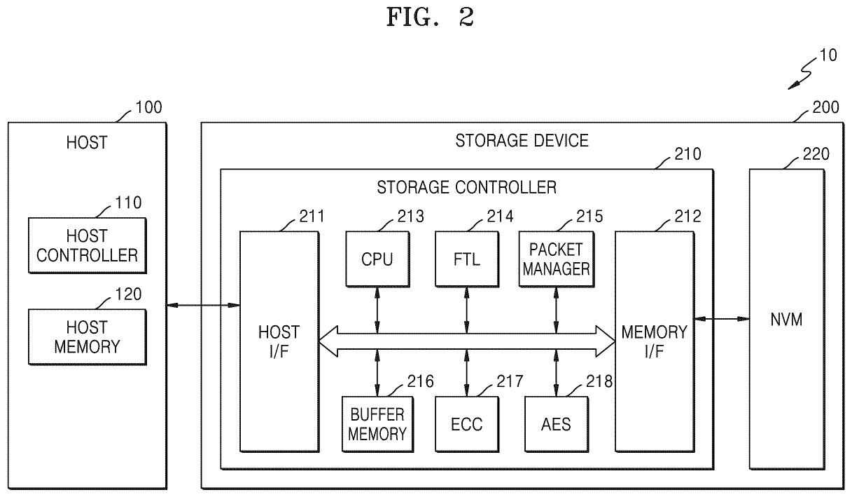

Referring to FIG. 1, the host-storage system 10 may include a host 100 and a storage device 300. The storage device 300 may include a host interface device 310, at least one media interface device 320 and 330, and a non-volatile memory (NVM) device 340. The storage device 300 may include storage mediums for storing data according to a request from the host 100. Detailed operations of the host 100 and the storage device 300 are described in detail below with reference to FIG. 2.

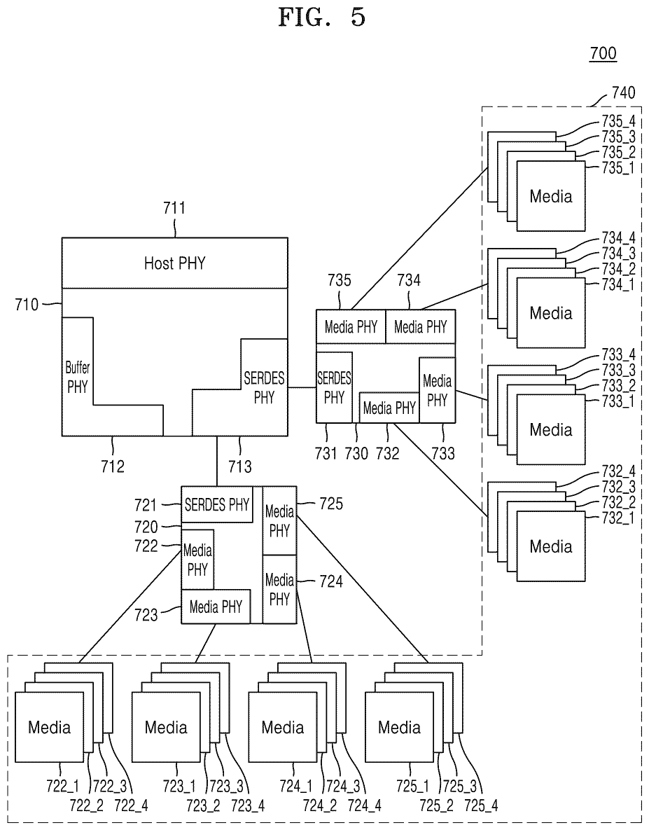

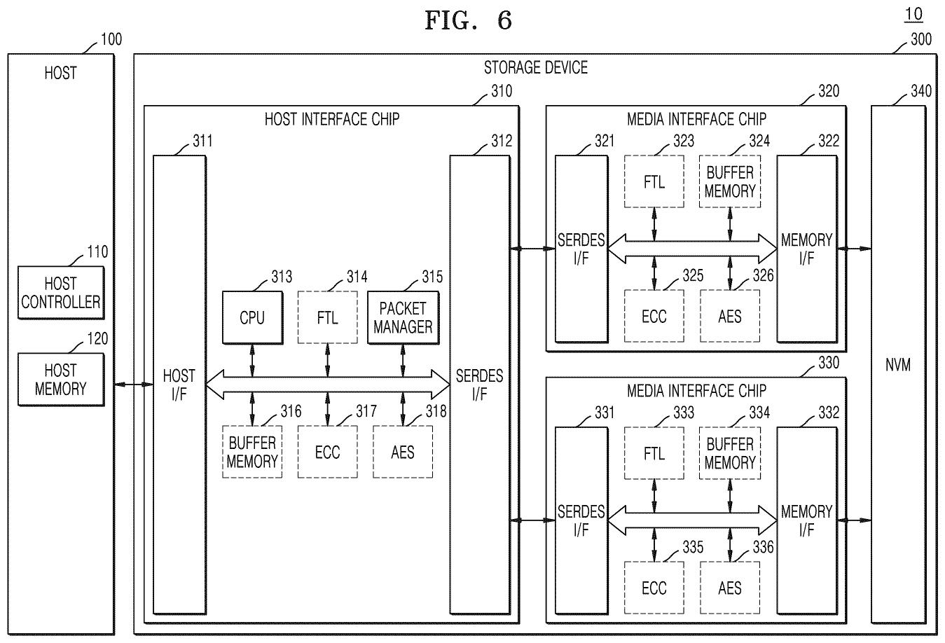

The host interface device 310 and at least one media interface device 320 and 330 may perform a storage controller operation of the storage device. A storage controller may be provided inside the storage device 300 and may perform a series of processes to store data according to a request received by the storage device from the host 100. For example, a host interface portion inside the storage controller may be configured as the host interface device 310, and a media interface portion inside the storage controller may be configured as at least one media interface device 320 and 330, separately. FIG. 1 shows an example in which two media interface devices are provided, but embodiments are not limited thereto. Although the NVM device 340 is illustrated as a single block, a plurality of NVM devices 340 may be provided. The at least one media interface device 320 and 330 may be connected to the plurality of NVM devices. The storage device including the host interface device 310 and the media interface devices 320 and 330 is described in detail below with reference to FIGS. 5 and 6.

FIG. 2 is a block diagram illustrating a host-storage system 10 according to a related example.

The host-storage system 10′ may include a host 100 and a storage device 200. In addition, the storage device 200 may include a storage controller 210 and an NVM 220. In addition, according to an embodiment, the host 100 may include a host controller 110 and a host memory 120. The host memory 120 may operation as a buffer memory for temporarily storing data to be transmitted to the storage device 200 or data transmitted from the storage device 200.

The storage device 200 may include storage mediums for storing data according to a request from the host 100. As an example, the storage device 200 may include at least one of a solid-state drive (SSD), embedded memory, and removable external memory. When the storage device 200 is an SSD, the storage device 200 may be a device that complies with a non-volatile memory express (NVMe) standard. When the storage device 200 is an embedded memory or external memory, the storage device 200 may be a device that follows a universal flash storage (UFS) or embedded multi-media card (eMMC) standard. The host 100 and the storage device 200 may each generate and transmit a packet according to an adopted standard protocol.

When the NVM 220 of the storage device 200 includes flash memory, the flash memory may include a 2D NAND memory array or a 3D (or vertical) NAND (VNAND) memory array. As another example, the storage device 200 may include various other types of non-volatile memories. For example, the storage device 200 may include MRAM, spin-transfer torque MRAM, conductive bridging RAM (CBRAM), ferroelectric RAM (FeRAM), PRAM, RRAM, and various other types of memories.

According to an embodiment, the host controller 110 and the host memory 120 may be implemented as separate semiconductor chips. According to another embodiment, in some embodiments, the host controller 110 and the host memory 120 may be integrated into the same semiconductor chip. As an example, the host controller 110 may be one of multiple modules provided in an application processor, and the application processor may be implemented as a system-on-chip (SoC). In addition, the host memory 120 may be an embedded memory provided within the application processor or may be a NVM or memory module located outside the application processor.

The host controller 110 may manage an operation of storing data (e.g., write data) of a buffer region in the NVM 220 or storing data (e.g., read data) of the NVM 220 in the buffer region.

The storage controller 210 may include a host interface (I/F) 211, a memory I/F 212, and a central processing unit (CPU) 213. In addition, the storage controller 210 may further include a flash translation layer (FTL) 214, a packet manager 215, a buffer memory 216, an error correction code (ECC) engine 217, and an advanced encryption standard (AES) 218. The storage controller 210 may further include a working memory into which the FTL, 214 is loaded, and a data write and read operation on the NVM 220 may be controlled as the CPU 213 executes the FTL 214.

The host I/F 211 may transmit and receive packets to and from the host 100. Packets transmitted from the host 100 to the host I/F 211 may include a command or data to be written into the NVM 220, and packets transmitted from the host I/F 211 to the host 100 may include a response to a command or data read from the NVM 220. The memory I/F 212 may transmit data to be written into the NVM 220 to the NVM 220 or receive data read from the NVM 220. The memory I/F 212 may be implemented to comply with standard protocols, such as Toggle or ONFI.

The FTL 214 may perform several operations, such as address mapping, wear-leveling, and garbage collection. Address mapping is an operation of changing a logical address received from the host 100 into a physical address used to store data in the NVM 220. Wear-leveling is a technology to prevent excessive deterioration of specific blocks by ensuring that blocks in the NVM 220 are used uniformly, and may be implemented, for example, through a firmware technology that balances erase counts of physical blocks. Garbage collection is a technology for securing available capacity in the NVM 220 by copying valid data of a block to a new block and then erasing an existing block.

The packet manager 215 may generate packets according to a protocol of an I/F negotiated with the host 100 or parse various information from packets received from the host 100. In addition, the buffer memory 216 may temporarily store data to be written into the NVM 220 or data to be read from the NVM 220. The buffer memory 216 may be provided within the storage controller 210 or may also be located outside the storage controller 210.

The ECC engine 217 may perform an error detection and correction operation on read data read from the NVM 220. For example, the ECC engine 217 may generate parity bits for write data to be written into the NVM 220, and the generated parity bits may be stored in the NVM 220 together with the write data. When reading data from the NVM 220, the ECC engine 217 may correct errors in the read data using the parity bits read from the NVM 220 together with the read data and output error-corrected read data.

The AES engine 218 may perform at least one of an encryption operation and a decryption operation on data input to the storage controller 210 using a symmetric-key algorithm.

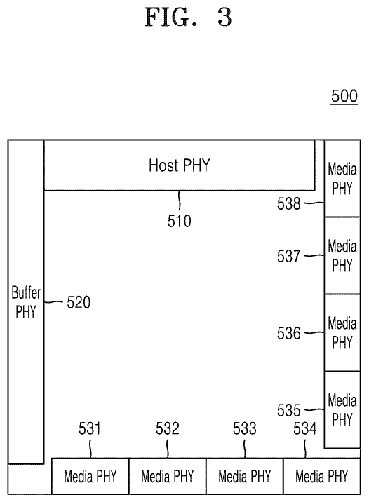

FIG. 3 is a block diagram illustrating a storage controller substrate 500 according to a related example.

Referring to FIG. 3, the storage controller substrate 500 may include a host physical layer (PHY) 510, a buffer PHY 520, and a plurality of media PHYs 531, 532, 533, 534, 535, 536, 537, and 538 at the edge. The storage controller substrate 500 may represent a substrate on which the storage controller 210 of FIG. 2 described above is manufactured. Each PHY is a physical layer and may operation as a physical connection terminal to connect to external devices. For example, the host PHY 510 may be connected to an external host device, and the buffer PHY 520 may be connected to various elements, such as external DRAM and PRAM. In the storage controller substrate 500 of FIG. 3, a central circuit wiring is omitted to focus on pads at the edge of the substrate, but a plurality of wirings may be located in the center, and the PHYs of a pad portion may be arranged differently. In FIG. 3, eight media PHYs 531 to 538 are illustrated, but this is illustrative and a different number of media PHYs may be formed on the pad.

The storage controller substrate 500 is a substrate created in the process of physically manufacturing a semiconductor device, and as semiconductor structure become more integrated and miniaturized, the size of the storage controller substrate 500 may be manufactured smaller. Accordingly, the pad region existing at the edge of the storage controller substrate 500 may also be reduced. The PHY for physical connection may have limitations in reducing the size thereof. Accordingly, the pad of the storage controller substrate 500 illustrated in FIG. 3 may be saturated to reach a pad limitation. Therefore, an additional PHY may not be located on the pad of the storage controller substrate 500. When the PHY for physical connection is located in the center of the substrate, it may be required for the PHY to be sufficiently secured on the pad because an electrical connection cannot be made on a plane.

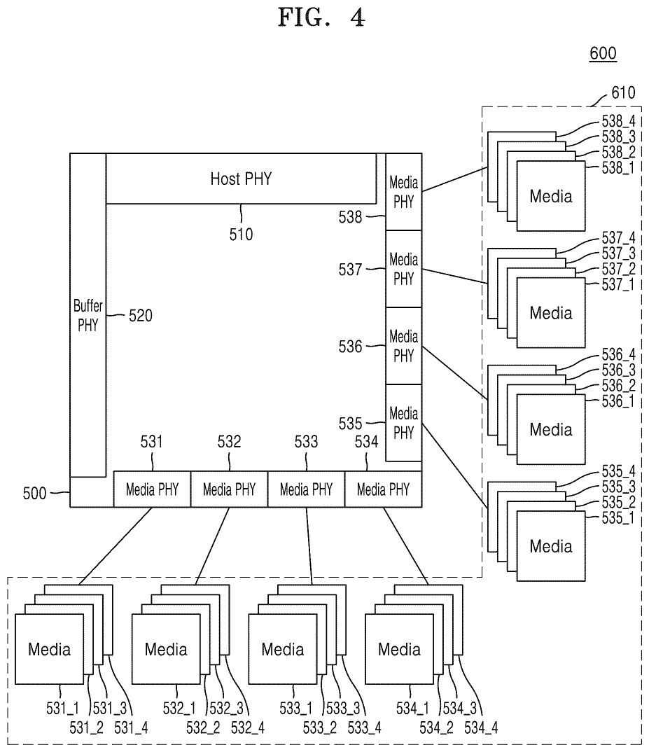

FIG. 4 is a block diagram illustrating a substrate of a storage device 600 according to a related example.

For example, FIG. 4 illustrates an example in which the storage controller substrate 500 of FIG. 3 is connected to a plurality of NVM devices 610 to form the storage device 600. The plurality of NVM devices 610 may correspond to the NVM device 220 described above with reference to FIG. 2 and the like, and may also be referred to as memory devices, media, etc. Redundant descriptions with reference to FIG. 3 regarding the storage controller substrate 500 are omitted.

The storage controller substrate 500 located inside the storage device 600 may be electrically connected to the media PHYs 531, 532, 533, 534, 535, 536, 537, and 538 and the NVM devices 610. A connection form shown in FIG. 4 is an example, and the number of PHYs and the number of NVM devices 610 are not limited thereto.

For example, a first set of NVM devices 531_1 to 531_4 may be electrically connected to the first media PHY 531, and an eighth set of NVM devices 538_1 to 538_4 may be electrically connected to the eighth media PHY 538. Each of the media PHYs 531 to 538 may be connected to a certain amount of NVM devices. The storage controller substrate 500 may transmit data corresponding to a command received from an external host to the NVM devices 610 through the media PHYs 531 to 538.

FIG. 5 is a block diagram illustrating a substrate of a storage device 700 according to an embodiment.

Referring to FIG. 5, the storage device 700 may include a host I/F circuit substrate 710, a first media I/F circuit substrate 720, a second media I/F circuit substrate 730, and a plurality of NVM devices 740. The host I/F circuit substrate 710, the first media I/F circuit substrate 720, and the second media I/F circuit substrate 730 may represent the substrate on which the host I/F device 310 of FIG. 1 and at least one media I/F device 320 and 330 described above are manufactured. The plurality of NVM devices 740 may represent the NVM device 340 of FIG. 1 or the NVM devices 610 of FIG. 4. Redundant descriptions with reference to FIGS. 1 and 4 regarding the storage device 700 are omitted.

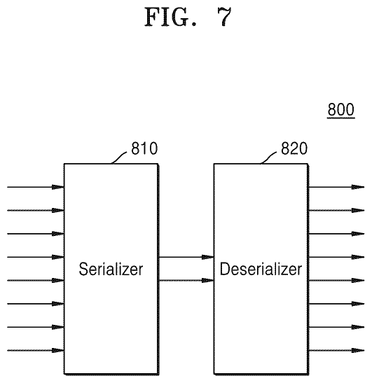

The host I/F circuit substrate 710 may include a host PHY 711, a buffer PHY 712, and a host serializer-deserializer (SerDes) PHY 713. The host PHY 711 and the buffer PHY 712 may correspond to the host PHY 510 and the buffer PHY 520 of FIG. 3, respectively. The first media I/F circuit substrate 720 may include a first media SerDes PHY 721 and a plurality of media PHYs 722 to 725. Similarly, the second media I/F circuit substrate 730 may include a second SerDes PHY 731 and a plurality of media PHYs 732 to 735. The media PHYs 722 to 725 and 732 to 735 may correspond to the media PHYs 531 to 538 in FIG. 3. The host SerDes PHY 713 may configure a SerDes with the first media SerDes PHY 721 and the second media SerDes PHY 731 to transmit data. Details regarding the SerDes are described in detail below with reference to FIG. 7.

The host I/F circuit substrate 710, the first media I/F circuit substrate 720, and the second media I/F circuit substrate 730 communicate through a SerDes connection and may operation overall like the storage controller substrate 510 of FIG. 3. For example, the host I/F device 310 of FIG. 1 and the at least one media I/F device 320 and 330 may perform the operation of the storage controller 210 of FIG. 2. The media PHYs 722 to 725 and 732 to 735 may be connected to the NVM devices 740, and redundant descriptions with reference to FIG. 4 in this regard are omitted.

In order to solve the pad limitation of the storage controller 500 of FIGS. 3 and 4, the host I/F circuit substrate 710, the first media I/F circuit substrate 720, and the second media I/F circuit substrate 730 of FIG. 5 may be configured separately. Data may be transmitted between the host I/F circuit substrate 710, the first media I/F circuit substrate 720, and the second media I/F circuit substrate 730 through a SerDes connection, but the media PHYs, which are portions that require multiple PHYs, are located in the media I/F circuit substrates 720 and 730, thereby solving the pad limitation of the substrate. In addition, the number of I/F circuit substrates and the number of media PHYs may be flexible, and flexible circuit design may be achieved as the pad limitation is eliminated.

Because the host I/F circuit substrate 710 processes commands from a host and performs various operations described above with reference to FIG. 2, relatively high-speed data processing may be required, and to this end, the host I/F circuit substrate may be required to be produced through an advanced process. In contrast, the media I/F circuit substrates 720 and 730, which mainly perform the operation of exchanging data with the NVM devices 700, may not require relatively high-speed data processing and it may be effective to produce the media I/F circuit substrates 720 and 730 through a cost-effective maturation process. Therefore, according to the embodiment described above, the yield of circuit manufacturing may be increased and production costs may be reduced by reflecting the fineness of the processes required for the host I/F device and the media I/F devices, respectively.

FIG. 6 is a block diagram illustrating the host-storage system 10 of FIG. 1 in more detail.

Referring to FIG. 6, the host-storage system 10 may include the host 100 and the storage device 300. The storage device 300 may include the host interface device 310, the at least one media interface device 320 and 330, and the NVM device 340. Redundant descriptions with reference to FIGS. 1 and 2 regarding the host-storage system 10 are omitted.

The host I/F device 310 may include a host I/F 311, a host SerDes I/F 312, a packet manager 315, and a CPU 313. The host I/F 311 may communicate with the host 100 to exchange data, and the host SerDes I/F 312 may be connected to a first media SerDes I/F 321 and a second media SerDes I/F 331 in a SerDes manner to exchange data. Redundant descriptions with reference to FIGS. 5 and 7 regarding SerDes are omitted.

The first media I/F device 320 may include the first media SerDes I/F 321 and a first memory I/F 322, and the second media I/F device 330 may include the second media SerDes I/F 331 and a second memory I/F 332. The first memory I/F 322 and the second memory I/F 332 may communicate with the NVM device 340 to exchange data.

The first memory I/F 322 and the second memory I/F 332 may communicate through a frequency boosting I/F (FBI) method. For example, the first memory I/F 322 and the second memory I/F 332 may include an FBI. The FBI method may increase a signal transmission rate by reducing a capacitance effect for input/output ports of NVM devices. For example, the FBI method may electrically separate the input/output ports of each NVM device using a switching circuit unit, such as a multiplexer. Accordingly, the signal transmission rate may be increased by reducing the capacitance effect for the input/output ports of the NVM devices.

The host I/F device 310 may further include an FTL 314, buffer memories 324 and 334, an ECC engine 317, and an AES engine 318 in some cases. The FTL 314, buffer memory 316, ECC engine 317, and AES engine 318 may correspond to the FTL 214, buffer memories 324 and 334, the ECC engine 217, and the AES engine 218.

In addition, the first media I/F device 320 may further include an FTL 323, a buffer memory 324, an ECC engine 325, and an AES engine 326 in some cases, and the second media I/F device 330 may further include an FTL 333, a buffer memory 334, an ECC engine 335, and an AES engine 336 engine in some cases. The FTLs 323 and 333, the buffer memories 324 and 334, the ECC engines 325 and 335, and the AES engines 326 and 336 may correspond to the FTL 214, the buffer memory 216, the ECC engine 217, and the AES engine 218.

The first media I/F device 320 and the second media I/F device 330 may perform an operation offloaded from the host I/F device 310 on behalf of the host I/F device 310. For example, unlike the storage controller 210 of FIG. 2, the FTL, buffer memory, ECC engine, and AES engine may be performed separately by the host I/F device 310 and the media I/F devices 320 and 330. For example, the host I/F device 310 may include the FTL 314, the buffer memories 324 and 334, and the AES engine 318, and the first media I/F device 320 and the second media I/F device 330 may include the ECC engines 325 and 335. Offloading may not necessarily have to exist selectively in only one location, and the host I/F device 310, the first media I/F device 320, and the second media I/F device 330 may all perform the operation. For example, the host I/F device 310, the first media I/F device 320, and the second media I/F device 330 may all include buffer memories 316, 324, and 334.

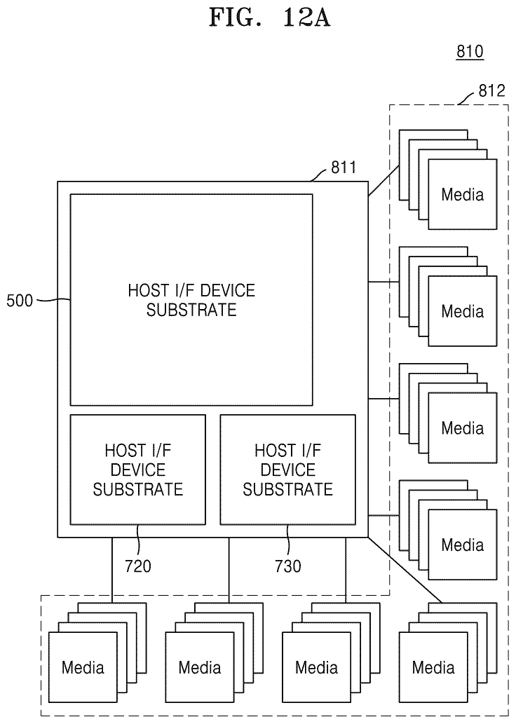

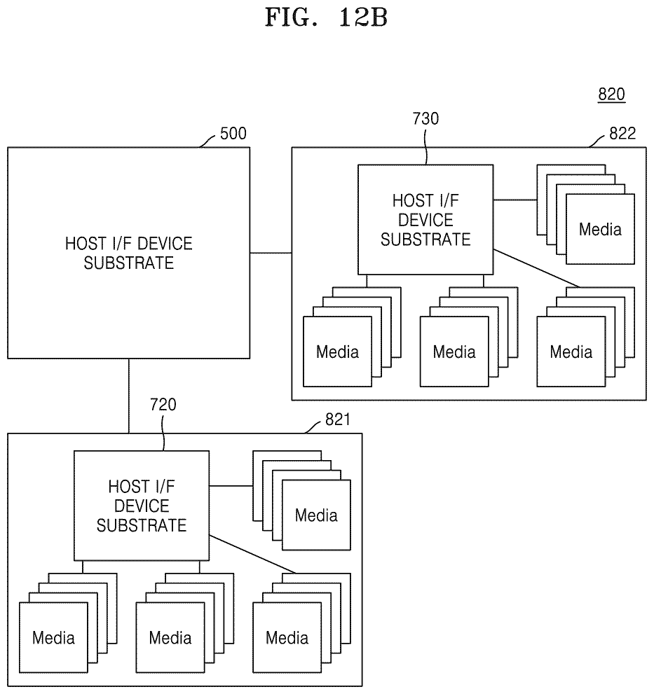

The first media I/F device 320 and the second media I/F device 330 may provide an operation beyond solving the pad limitation by performing an operation offloaded from the host I/F device 310 on behalf of the host I/F device 310. As is described below with reference to FIGS. 12A and 12B, the first media I/F device 320 and the second media I/F device 330 may be appropriately packaged with peripheral chips to be used or may form an independent chip or chiplet structure.

FIG. 7 is a block diagram illustrating a SerDes 800 according to an embodiment.

Referring to FIGS. 5 and 7, the host SerDes I/F 312, the first media SerDes I/F 321, and the second media SerDes I/F 331 may each include at least a portion of the SerDes 800.

The SerDes 800 may be an I/F that supports communication between one device and another device. The SerDes 800 may convert parallel data into serial data or convert serial data into parallel data. The SerDes 800 in this specification may be a transceiver. The parallel data may be data including deserialized bits, and the serial data may be data including serialized bits.

In an embodiment, the SerDes 800 may include a serializer 810 and a deserializer 820.

The serializer 810 may transmit data (or a signal) to the deserializer 820. Pins of an integrated circuit in which the serializer 810 is implemented may increase the cost required to implement the SerDes 800. To reduce the implementation cost, the serializer 810 may transmit data including serialized bits. The serializer 810 may receive parallel data and output serial data. The serializer 810 may transmit signals using, for example, single-ended signaling. For another example, the serializer 810 may transmit a pair of signals using double-ended signaling or differential signaling. The serializer 810 in this specification may be referred to as a transmitter or TX.

The deserializer 820 may receive data (or signals) transmitted from the serializer 810. The deserializer 820 may receive serial data and output parallel data. The deserializer 820 may include an amplifier and an equalizer to restore a transmission signal or compensate for channel loss.

The SerDes 800 may further include a channel. The channel may be a path that physically or electrically connects the serializer 810 to the deserializer 820. The channel may be formed between the serializer 810 and the deserializer 820. The channel may be implemented using a printed circuit board (PCB) trace or a coaxial cable. The channel may deteriorate a high frequency component of a signal due to a skin effect, dielectric loss, etc. When a signal is transmitted through the channel, channel loss may occur in the deserializer 820. Impedance discontinuity may occur due to connectors and other physical I/Fs between substrates and cables in the channel. The impedance discontinuity of the channel may appear as a notch in a frequency response of the channel. Reflection noise may occur in the deserializer 820 due to the impedance discontinuity of the channel. Each bit of data passing through the channel may interfere with the next bit(s) due to channel loss or bandwidth limitations, and as neighboring symbols overlap, a bit error rate (BER) may increase. The SerDes 800 may be generally manufactured based on a SerDes model modeled on a computer.

In an embodiment, the host SerDes I/F 312 may include the SerDes 800. The host SerDes I/F 312 may include the serializer 810 and the deserializer 820. The serializer 810 of the host SerDes I/F 312 may serialize commands or data to be transmitted to at least one media I/F device 320 and 330. The serializer 810 of the host SerDes I/F 312 may serialize a parallel signal and output a serial signal. The serializer 810 of the host SerDes I/F 312 may transmit a serial signal to at least one media I/F device 320 and 330. The deserializer 820 of the host SerDes I/F 312 may parallelize a serial signal. The deserializer 820 of the host SerDes I/F 312 may parallelize a serial signal received from at least one media I/F device 320 and 330 and output a parallel signal.

The first media SerDes I/F 321 may include the SerDes 800. The first media SerDes I/F 321 may include the serializer 810 and the deserializer 820. The serializer 810 of the first media SerDes I/F 321 may serialize a parallel signal and output a serial signal. The serializer 810 of the first media SerDes I/F 321 may transmit the serial signal to the host I/F device 310. The deserializer 820 of the first media SerDes I/F 321 may parallelize a serial signal. The deserializer 820 of the first media SerDes I/F 321 may parallelize the serial signal received from the host I/F device 310 and output a parallel signal.

The second media SerDes I/F 331 may include the SerDes 800. The first media SerDes I/F 321 may include the serializer 810 and the deserializer 820. The serializer 810 of the second media SerDes I/F 331 may serialize a parallel signal and output a serial signal. The serializer 810 of the second media SerDes I/F 331 may transmit the serial signal to the host I/F device 310. The deserializer 820 of the second media SerDes I/F 331 may parallelize a serial signal. The deserializer 820 of the second media SerDes I/F 331 may parallelize the serial signal received from the host I/F device 310 and output a parallel signal.

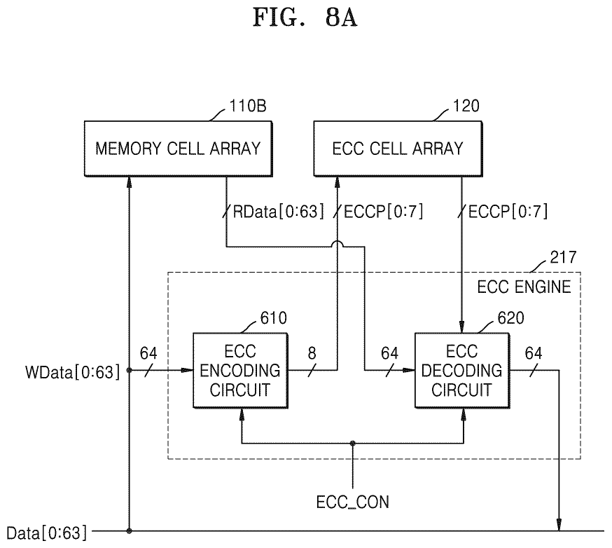

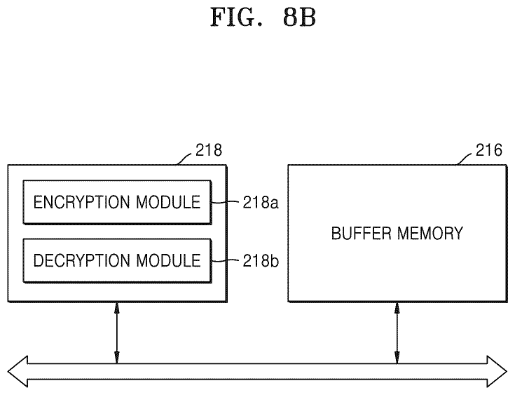

FIG. 8A is a block diagram illustrating the ECC engines 325 and 335 of FIG. 6 in more detail.

Referring to FIGS. 6 and 8A, the media I/F devices 320 and 330 may include the ECC engines 325 and 335, respectively. The ECC engines 325 and 335 may include an ECC encoding circuit 610 and an ECC decoding circuit 620. In response to an ECC control signal ECC_CON, the ECC encoding circuit 610 may generate parity bits ECCP [0:7] for write data WData [0:63] to be written into memory cells of a second block 110B of a memory cell array. Parity bits ECCP [0:7] may be stored in an ECC cell array 120. According to an embodiment, in response to an ECC control signal ECC_CON, the ECC encoding circuit 610 may generate the parity bits ECCP [0:7] for the write data WData [0:63] to be written into memory cells including a defective cell of the second block 110B.

In response to the ECC control signal ECC_CON, the ECC decoding circuit 620 may correct error bit data using the read data RData [0:63] read from the memory cells of the second block 110B of the memory cell array and the parity bits ECCP [0:7] read from the ECC cell array 120 and output error-corrected data Data [0:63]. According to an embodiment, the ECC decoding circuit 620 may correct error bit data using the read data RData [0:63] read from the memory cells including a defective cell of the second block 110B and the parity bits ECCP [0:7] read from the ECC cell array 120 and output error-corrected data Data [0:63].

In an embodiment, the ECC engines 325 and 335 of the respective media I/F devices 320 and 330 may perform an ECC operation. Each of the media I/F devices 320 and 330 may perform an ECC operation on behalf of the host I/F device 310. For example, the first media I/F device 320 may receive write data from the host I/F device 310 through serial communication. The ECC engine 325 may perform an encoding operation. The ECC engine 325 may generate a parity bit for the write data. The ECC engine 325 may transmit the write data and the parity bit to the first memory I/F 322.

The ECC engine 325 may receive read data and a parity bit from the first memory I/F 322. The ECC engine 325 may perform an error correction operation. The ECC engine 325 may perform error correction on the read data based on the parity bit. The ECC engine 325 may transmit error-corrected data to the first media SerDes I/F 321. The first media I/F device 320 may transmit the error-corrected data to the host I/F device 310 through serial communication.

FIG. 8B is a block diagram illustrating the AES engine of FIG. 6 in more detail.

Referring to FIGS. 6 and 8B, the media I/F devices 320 and 330 may include AES engines 326 and 336, respectively. The AES engines 326 and 336 may perform encryption and decryption of data using an AES algorithm and may include an encryption module 218a and a decryption module 218b. FIG. 8B shows the encryption module 218a and the decryption module 218b implemented as separate modules, but embodiments are not limited thereto, and a single module capable of performing both encryption and decryption may also be implemented in the AES engines 326 and 336. The buffer memory 216 may be a volatile memory that serves as a buffer or may be a NVM. The buffer memories 324 and 334 in FIG. 6 may represent the buffer memory 216 as an example.

The AES engines 326 and 336 may receive first data transmitted from the buffer memory 216. The encryption module 218a may generate second data by encrypting first data transmitted from the buffer memory 216 using an encryption key. The second data may be transmitted from the AES engines 326 and 336 to the buffer memory 216 and stored in the buffer memory 216.

In addition, the AES engines 326 and 336 may receive third data transmitted from the buffer memory 216. The third data may be data encrypted with the same encryption key as an encryption key used to encrypt the first data. The decryption module 218b may generate fourth data by decrypting third data transmitted from the buffer memory 216 with the same encryption key as the encryption key used to encrypt the first data. The fourth data may be transmitted from the AES engines 326 and 336 to the buffer memory 216 and stored in the buffer memory 216.

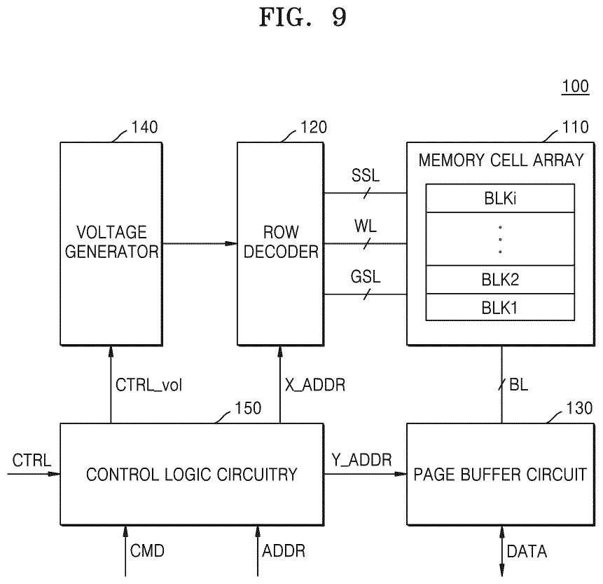

FIG. 9 is a block diagram illustrating the memory device 100 according to an embodiment.

As shown in FIG. 9, the memory device 100 may include a memory cell array 110, a row decoder 120, an input/output circuit 130, a voltage generator 140, and control logic 150. The memory device 340 of FIG. 6 may be an example of the memory device 100.

The memory cell array 110 may include a plurality of memory cells and may be connected to word lines WL, string select lines SSL, ground select lines GSL, and bit lines BL. For example, the memory cell array 110 may be connected to the row decoder 120 through the word lines WL or select lines SSL and GSL and to the input/output circuit 130 through the bit lines BL.

The memory cell array 110 may include a plurality of memory blocks BL1 to BLKi. The memory blocks BLK1 to BLKi may include at least one of a single-level cell block including single-level cells, a multi-level cell block including multi-level cells, and a triple-level cell block including triple-level cells. Some of the memory blocks included in the memory cell array 110 may be single-level cell blocks, and other blocks may be multi-level cell blocks or triple-level cell blocks.

In an embodiment, each memory block may have a three-dimensional structure (or a vertical structure). For example, each memory block may include a plurality of memory strings extending in a direction perpendicular to the substrate. However, embodiments are not limited thereto, and each memory block may have a two-dimensional structure.

When an erase voltage is applied to the memory cell array 110, the memory cells may be in an erase state, and when a program voltage is applied to the memory cell array 110, the memory cells may be in a program state. In this case, each memory cell may have an erase state E and at least one program state classified according to a threshold voltage Vth.

In an embodiment, when the memory cell is a single level cell, the memory cell may have an erased state and a program state. In another embodiment, when the memory cell is a multi-level cell, the memory cell may have an erase state and at least three program states.

The row decoder 120 may select some of the word lines WL in response to a row address X-ADDR. The row decoder 120 transfers a word line voltage to the word line. During a program operation, the row decoder 120 may apply a program voltage and a verification voltage to a selected word line and a program inhibit voltage to an unselected word line. The program inhibit voltage may be a high voltage. The high voltage may be a voltage having a level higher than a power supply voltage, which is generated by pumping the power supply voltage. The program voltage may be a high voltage having a level higher than that of the program inhibit voltage. During a read operation, the row decoder 120 may apply a read voltage to a selected word line and a read inhibit voltage to an unselected word line. In addition, the row decoder 120 may select some of the string select lines SSL or some of the ground select lines GSL in response to a row address X-ARRD.

The input/output circuit 130 may receive data from an external source (e.g., a controller) and store input data in the memory cell array 110. In addition, the input/output circuit 130 may read data from the memory cell array 110 and output the read data to an external device or the control logic 150. The input/output circuit 130 may include page buffers corresponding to the bit lines BL. In addition, the input/output circuit 130 may include components, such as a column select gate, a data buffer, a write driver, and a sense amplifier. The page buffer may be connected to the memory cell array 110 through the bit lines BL, and may select some of the bit lines BL in response to a column address Y-ADDR received from the control logic 150. During a program operation, the page buffer may operate as a write driver to program data DATA to be stored in the memory cell array 110.

The voltage generator 140 may generate various types of voltages to perform program, read, and erase operations on the memory cell array 110 based on a voltage control signal CTRL_vol. For example, the voltage generator 140 may generate a word line voltage, for example, a program voltage (or a write voltage), a read voltage, a pass voltage (or a word line non-selection voltage), or a verification voltage. The voltage generator 140 may generate a bit line voltage, for example, a bit line forcing voltage, an inhibit voltage, etc. In addition, the voltage generator 140 may further generate a string select line voltage and a ground select line voltage based on a voltage control signal CTRL_vol. In an embodiment, the voltage generator 140 may generate a program pulse and a verification voltage having a level changing as the number of program loops increases based on the voltage control signal CTRL_vol. When a program loop is performed, a programming method according to an embodiment may be performed in an incremental step pulse programming (ISPP) manner, and the voltage generator 140 may generate a program pulse having a level gradually increasing to be higher than that of a previous program voltage each time the program loop is performed.

The control logic 150 may output various control signals for writing data into the memory cell array 110 or reading data from the memory cell array 110 based on the command CMD, address ADDR, and control signal CTRL received from the controller. Accordingly, the control logic 150 may generally control various operations within the memory device 100. In addition, the control logic 150 may control the voltage generator 140 to generate at least one verification voltage and at least one program pulse in each program loop.

Various control signals output from the control logic 150 may be provided to the voltage generator 140, the row decoder 120, and the input/output circuit 130. For example, the control logic 150 may provide the voltage control signal CTRL_vol to the voltage generator 140, the row address X-ADDR to the row decoder 120, and the column address Y-ADDR to the input/output circuit 130. However, embodiments are not limited thereto, and the control logic 150 may further provide other control signals to the voltage generator 140, the row decoder 120, and the input/output circuit 130. In addition, the control logic 150 may control the overall operations performed by the overall memory device 100 based on commands received from the controller, and the control logic 150 may perform operations performed by a program controller. The program controller within the control logic 150 may be implemented as a hardware component or may be implemented as a firmware component.

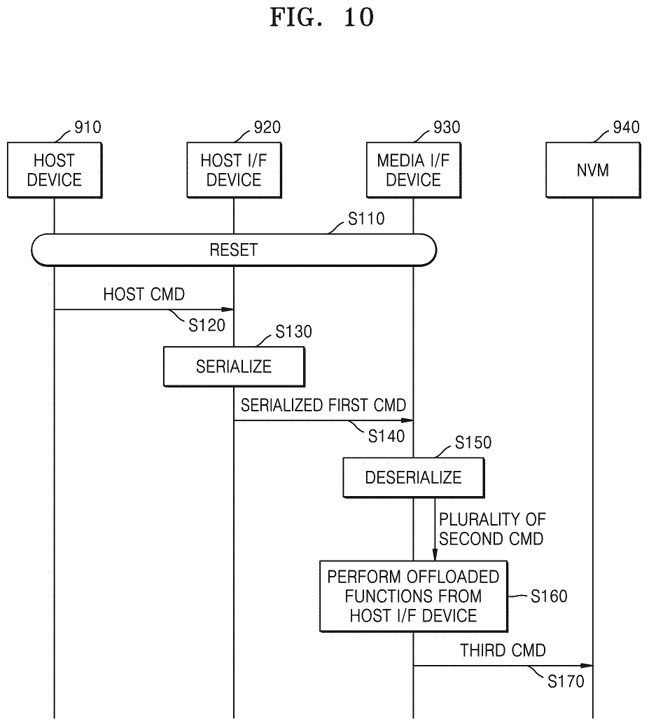

FIG. 10 is a flowchart illustrating an operating method of a host-storage system according to an embodiment.

Referring to FIG. 10, a host device 910, a host I/F device 920, a media I/F device 930, and a NVM device 940 may be connected to neighboring devices to exchange data. The host device 910, the host I/F device 920, the media I/F device 930, and the NVM device 940 may correspond to, for example, the host device 100, the host I/F device 310, the media I/F device 320 or 330, and the NVM device 340 of FIG. 6, and redundant descriptions given above are omitted.

The host-storage system 10 may operate by performing a plurality of operations S110 to S170. In operation S110, the host device 910, the host I/F device 920, and the media I/F device 930 may be reset (or powered up). After the host device 910, the host I/F device 920, and the media I/F device 930 are reset, the host I/F device 920 may receive a plurality of host commands from the host device 910 in operation S120. In operation S130, the host I/F device 920 may serialize the host commands to generate a first command.

In operation S140, the media I/F device 930 may receive the serialized first command. In operation S150, the media I/F device 930 may deserialize the first command to generate a plurality of second commands. A result of performing the operations S130 to S150 may correspond to SerDes type data transfer.

In operation S160, the media I/F device 930 may perform an operation offloaded from the host I/F device on the second commands to generate a plurality of third commands. Descriptions related to the offloaded operation may be an operation of the FTL, the ECC engine, and the AES engine as described above with reference to FIG. 6. In operation S170, the media I/F device 930 may transmit the third commands respectively to a plurality of NVM devices.

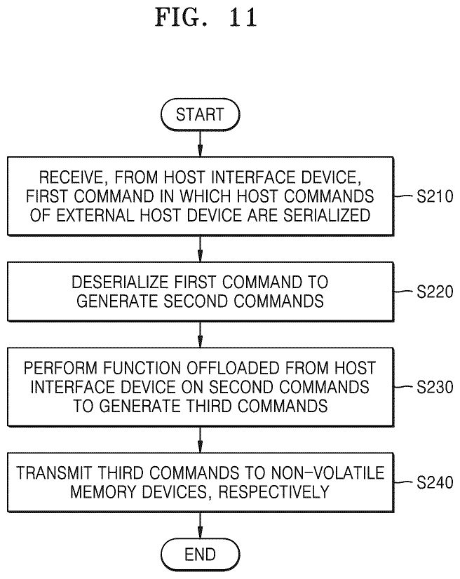

FIG. 11 is a flowchart illustrating an operating method of a media I/F device according to an embodiment.

Referring to FIG. 11, the media I/F device 930 may operate by performing a plurality of operations S210 to S240. Redundant descriptions with reference to FIG. 10 regarding the operations of the media I/F device 930 are omitted.

In operation S210, the media I/F device 930 may receive a first command obtained by serializing a plurality of host commands of an external host device from the host I/F device. In operation S220, the media I/F device 930 may generate a plurality of second commands by deserializing the first command. In operation S230, the media I/F device 930 may generate a plurality of third commands by performing an operation offloaded from the host I/F device on the second commands. Descriptions related to offloaded operation may be an operation of the FTL, the ECC engine, and the AES engine as described above with reference to FIG. 6. In operation S240, the media I/F device 930 may transmit the third commands to a plurality of NVM devices.

According to the embodiment described above, by separately configuring the host I/F and the media I/F of the storage controller and connecting them using a SerDes method, the pad limitation may be solved and flexible circuit design may be achieved. In addition, according to the embodiment described above, the yield of circuit manufacturing may increase and production costs may be reduced by reflecting fineness of the processes required for the host I/F device and the media I/F device, separately.

FIGS. 12A and 12B are block diagrams illustrating a packaging form of a media I/F device according to an embodiment.

For example, FIGS. 12A and 12B illustrate a media I/F device being chipletized and forming a storage device through this. Redundant descriptions regarding the storage device, host I/F device, and media I/F device are omitted.

Referring to FIG. 12A, the host I/F device substrate 500 and at least one media I/F device substrate 720 and 730 are chiplets forming a single package 811, and the formed package 811 may be connected to the NVM devices 812 to form the storage device 810.

Also, referring to FIG. 12B, the first media I/F device substrate 720 may be connected to a plurality of NVM devices to form a first package 821, and the second media I/F device substrate 730 may be connected to a plurality of NVM devices to form a second package 822. The first package 821 and the second package 822 may be connected to the host I/F device substrate 500 to form the storage device 820.

Because the host I/F circuit substrate 500 processes commands from a host and performs various operations described above with reference to FIG. 2, relatively high-speed data processing may be frequently required, and to this end, the host I/F circuit substrate may be required to be produced through an advanced process. In contrast, the media I/F circuit substrates 720 and 730, which mainly perform the operation of exchanging data with the NVM devices 812, may not require relatively high-speed data processing and it may be effective to produce the media I/F circuit substrates 720 and 730 through a cost-effective maturation process. Therefore, according to the embodiment described above, the yield of circuit manufacturing may be increased and production costs may be reduced by reflecting the fineness of the processes required for the host I/F device and the media I/F devices, respectively.

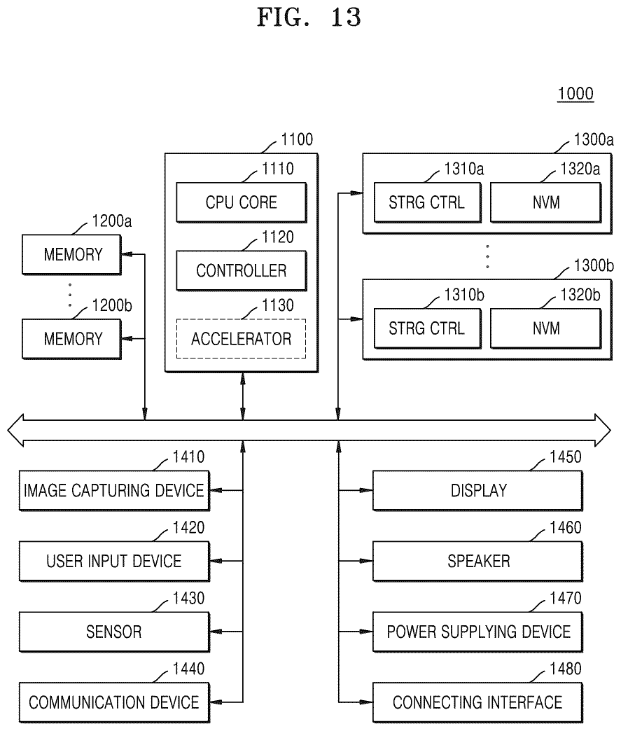

FIG. 13 is a block diagram illustrating a system 1000 to which a storage device according to an embodiment is applied.

The system 1000 of FIG. 13 may be a mobile system, such as a portable communication terminal (or a mobile phone), a smartphone, a tablet personal computer (PC), a wearable device, a healthcare device, or an Internet of things (IoT) device. However, the system 1000 of FIG. 13 is not necessarily limited to a mobile system, but may include, for example, personal computers, laptop computers, servers, media players, or automotive devices, such as navigation systems, etc.

Referring to FIG. 13, the system 1000 may include a main processor 1100, memories 1200a and 1200b, and storage devices 1300a and 1300b, and may additionally include an image capturing device 1410, a user input device 1420, a sensor 1430, a communication device 1440, a display 1450, a speaker 1460, a power supplying device 1470, and a connection interface 1480.

The main processor 1100 may control the overall operation of the system 1000, and in detail, the operation of other components forming the system 1000. The main processor 1100 may be implemented as a general-purpose processor, a dedicated processor, or an application processor.

The main processor 1100 may include one or more CPU cores 1110 and may further include a controller 1120 for controlling the memories 1200a and 1200b and/or the storage devices 1300a and 1300b. According to an embodiment, the main processor 1100 may further include an accelerator block 1130, which is a dedicated circuit for high-speed data computation, such as artificial intelligence (AI) data computation. This accelerator block 1130 may include a graphics processing unit (GPU), a neural processing unit (NPU), and/or a data processing unit (DPU), and may also be implemented as a separate chip physically independent from other components of the main processor 1100.

The memories 1200a and 1200b may be used as main memory devices of the system 1000 and may include volatile memory, such as SRAM and/or DRAM, but may also include NVM, such as flash memory, PRAM and/or RRAM. The memories 1200a and 1200b may also be implemented in the same package as that of the main processor 1100.

The storage devices 1300a and 1300b may operation as non-volatile storage devices that store data regardless of whether power is supplied and may have a relatively large storage capacity compared to the memories 1200a and 1200b. The storage devices 1300a and 1300b may include storage controllers 1310a and 1310b and NVM 1320a and 1320b that store data under control by the storage controllers 1310a and 1310b. The NVMs 1320a and 1320b may include V-NAND flash memory having a 2-dimensional (2D) structure or a 3-dimensional (3D) structure or may also include other types of NVM, such as PRAM and/or RRAM.

The storage devices 1300a and 1300b may be included in the system 1000 in a state of being physically separate from the main processor 1100 or may be implemented in the same package as that of the main processor 1100. In addition, the storage devices 1300a and 1300b may have a form, such as a solid state device (SSD) or a memory card and may be connected to other components of the system 1000 through an I/F, such as a connection interface 1480 to be described below. Such storage devices (1300a, 1300b) may be devices to which standard protocols, such as universal flash storage (UFS), embedded multi-media card (eMMC), or NVM express (NVMe) are applied, but are not necessarily limited thereto.

The image capturing device 1410 may capture still images or moving images and may include a camera, camcorder, and/or webcam.

The user input device 1420 may receive various types of data input from the user of the system 1000, and may include a touch pad, a keypad, a keysubstrate, a mouse and/or a microphone, etc.

The sensor 1430 may detect various types of physical quantities that may be obtained from outside the system 1000 and convert the detected physical quantities into electrical signals. The sensor 1430 may include a temperature sensor, a pressure sensor, an illumination sensor, a position sensor, an acceleration sensor, a biosensor, and/or a gyroscope.

The communication device 1440 may transmit and receive signals to and from other devices outside the system 1000 according to various communication protocols. The communication device 1440 may be implemented to include an antenna, a transceiver, and/or a modem.

The display 1450 and the speaker 1460 may operation as output devices that output visual information and auditory information, respectively, to the user of the system 1000.

The power supplying device 1470 may appropriately convert power supplied from a battery built in the system 1000 and/or an external power source and supply the converted power to each component of the system 1000.

The connection interface 1480 may provide a connection between the system 1000 and an external device that is connected to the system 1000 to exchange data with the system 1000. The connection interface 1480 may be implemented according to various I/F methods, such as advanced technology attachment (ATA), serial ATA (SATA), external SATA (e-SATA), small computer small I/F (SCSI), serial attached SCSI (SAS), peripheral component interconnection (PCI), PCI express (PCle), NVM express (NVMe), IEEE 1394, universal serial bus (USB), secure digital (SD) card, multi-media card (MMC), embedded multi-media card (eMMC), universal flash storage (UFS), embedded universal flash storage (eUFS), compact flash (CF) card I/F, etc.

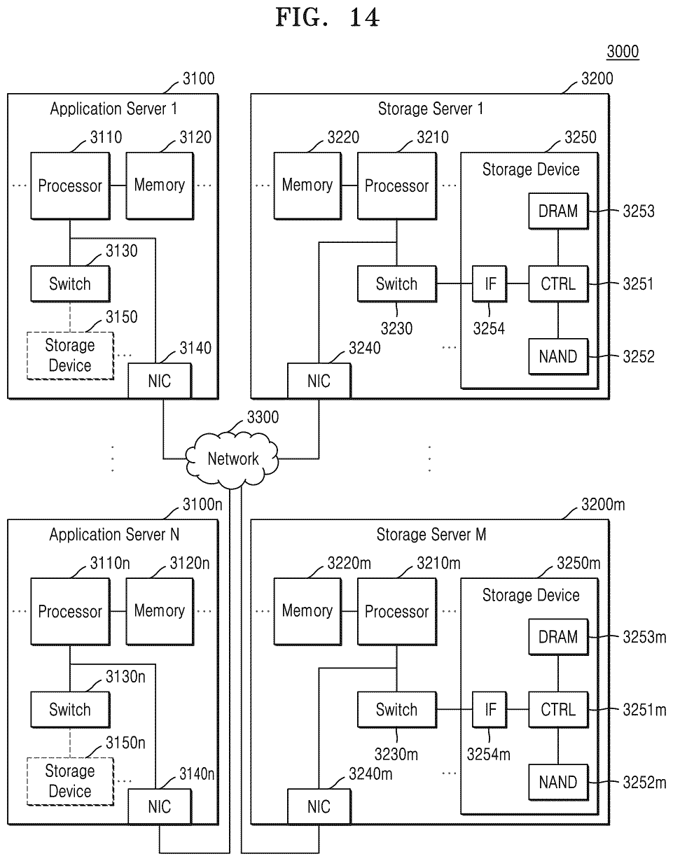

FIG. 14 is a block diagram illustrating a data center 3000 to which a storage device according to an embodiment is applied.

Referring to FIG. 14, the data center 3000 is a facility that collects various types of data and provides services, and may also be referred to as a data storage center. The data center 3000 may be a system for operating a search engine and database or may be a computing system used in companies, such as banks, or government agencies. The data center 3000 may include application servers 3100 to 3100n and storage servers 3200 to 3200m. The number of application servers 3100 to 3100n and the number of storage servers 3200 to 3200m may be selected variously according to an embodiment, and the number of application servers 3100 to 3100n may be different from the number of storage servers 3200 to 3200m.

The application server 3100 or the storage server 3200 may include at least one of processors 3110 and 3210 and memories 3120 and 3220. Referring to the storage server 3200 as an example, the processor 3210 may control an overall operation of the storage server 3200 and access the memory 3220 to execute instructions and/or data loaded into the memory 3220. The memory 3220 may include double data rate synchronous DRAM (DDR SDRAM), high bandwidth memory (HBM), hybrid memory cube (HMC), dual in-line memory module (DIMM), or non-volatile DIMM (NVMDIMM). According to an embodiment, the number of processors 3210 and memories 3220 included in the storage server 3200 may be selected variously. In an embodiment, the processor 3210 and the memory 3220 may provide a processor-memory pair. In an embodiment, the number of processors 3210 may be different from the number of memories 3220. The processor 3210 may include a single core processor or a multi-core processor. The above description of the storage server 3200 may be similarly applied to the application server 3100. According to an embodiment, the application server 3100 may not include the storage device 3150. The storage server 3200 may include at least one storage device 3250. The number of storage devices 3250 included in the storage server 3200 may be selected variously according to an embodiment.

The application servers 3100 to 3100n may communicate with and the storage servers 3200 to 3200m through a network 3300. The network 3300 may be implemented using fiber channel (FC) or Ethernet. Here, the FC is a medium used for relatively high-speed data transmission, and an optical switch that provides high performance/high availability may be used. Depending on an access method of the network 3300, the storage servers 3200 to 3200m may be provided as a file storage, a block storage, or an object storage.

In an embodiment, the network 1300 may be a storage-only network, such as a storage area network (SAN). For example, the SAN may be an FC-SAN that uses an FC network and is implemented according to an FC protocol (FCP). As another example, the SAN may be an IP-SAN that uses a TCP/IP network and is implemented according to an SCSI over TCP/IP or Internet SCSI (iSCSI) protocol. In other embodiments, the network 1300 may be a general network, such as a TCP/IP network. For example, the network 1300 may be implemented according to protocols, such as FC over Ethernet (FCOE), network attached storage (NAS), and NVMe over fabrics (NVMe-oF).

Hereinafter, the descriptions are given based on the application server 3100 and the storage server 3200. The description of the application server 3100 may also be applied to other application servers 3100n, and the description of the storage server 3200 may also be applied to other storage servers 3200m.

The application server 3100 may store data requested by the user or client to be stored in one of the storage servers 3200 to 3200m through the network 3300. In addition, the application server 3100 may obtain data requested by the user or client to be read from one of the storage servers 3200 to 3200m through the network 3300. For example, the application server 3100 may be implemented as a web server or a database management system (DBMS).

The application server 3100 may access the memory 3120n or the storage device 3150n included in another application server 3100n through the network 3300 or may access the memories 3220 to 3220m or the storage device 3250 to 3250m included in the storage servers 3200 to 3200m through the network 3300. Accordingly, the application server 3100 may perform various operations on data stored in the application servers 3100 to 3100n and/or the storage servers 3200 to 3200m. For example, the application server 3100 may execute a command to move or copy data between the application servers 3100 to 3100n and/or the storage servers 3200 to 3200m. Here, the data may move from the storage devices 3250 to 3250m of the storage servers 3200 to 3200m to the memories 3120 to 3120n of the application servers 3100 to 3100n through the memories 3220 to 3220m of the storage servers 3200 to 3200m or directly. The data moving through the network 3300 may be encrypted data for security or privacy.

Referring to the storage server 3200 as an example, an I/F 3254 may provide a physical connection between the processor 3210 and a controller 3251 and a physical connection between an NIC 3240 and the controller 3251. For example, the I/F 3254 may be implemented according to a direct attached storage (DAS) method that directly connects the storage device 3250 to a dedicated cable. In addition, for example, the I/F 1254 may be implemented according to various interface methods, such as ATA, SATA, e-SATA, SCSI, SAS, PCI, PCIe, NVMe, IEEE 1394, USB, SD card, MMC, eMMC, UFS, eUFS, CF card I/F, etc.

The storage server 3200 may further include a switch 3230 and the NIC 3240. The switch 3230 may selectively connect the processor 3210 to the storage device 3250 or the NIC 3240 to the storage device 3250 under control by the processor 3210.

In an embodiment, the NIC 3240 may include a network I/F card, network adapter, etc. The NIC 3240 may be connected to the network 3300 by a wired I/F, a wireless I/F, a Bluetooth I/F, an optical I/F, etc. The NIC 3240 may include an internal memory, a digital signal processor (DSP), a host bus I/F, etc., and may be connected to the processor 3210 and/or the switch 3230 through the host bus I/F. The host bus I/F may be implemented as one of the examples of the I/F 3254 described above. In an embodiment, the NIC 3240 may be integrated with at least one of the processor 3210, the switch 3230, and the storage device 3250.

In the storage servers 3200 to 3200m or the application servers 3100 to 3100n, the processor may transmit commands to the storage devices 3130 to 3130n and 3250 to 3250m or memories 3120 to 3120n and 3220 to 3220m to program or read data. Here, the data may be data which is error-corrected through an ECC engine. The data may be data that has been processed through data bus inversion (DBI) or data masking (DM) and may include cyclic redundancy code (CRC) information. The data may be encrypted for security or privacy.

The storage devices 3150 to 3150m and 3250 to 3250m may transmit a control signal and a command/address signal to the NAND flash memory devices 3252 to 3252m in response to a read command received from the processor. Accordingly, when data is read from the NAND flash memory devices 3252 to 3252m, a read enable (RE) signal may be input as a data output control signal and may serve to output data to a DQ bus. A data strobe (DQS) may be generated using the RE signal. The command and address signal may be latched to a page buffer according to a rising edge or falling edge of a write enable (WE) signal.

The controller 3251 may generally control the operation of the storage device 3250. In an embodiment, the controller 3251 may include static random access memory (SRAM). The controller 3251 may write data to the NAND flash 3252 in response to a write command or may read data from the NAND flash 3252 in response to a read command. For example, the write command and/or read command may be provided from the processor 3210 in the storage server 3200, the processor 3210m in another storage server 3200m, or the processor 3110 or 3110n in the application server 3100 or 3100n. A DRAM 3253 may temporarily store (buffer) data to be written into the NAND flash 3252 or data read from the NAND flash 3252. In addition, the DRAM 3253 may store metadata. Here, the metadata is data generated by the controller 3251 to manage user data or the NAND flash 3252. The storage device 3250 may include a secure element (SE) for security or privacy.

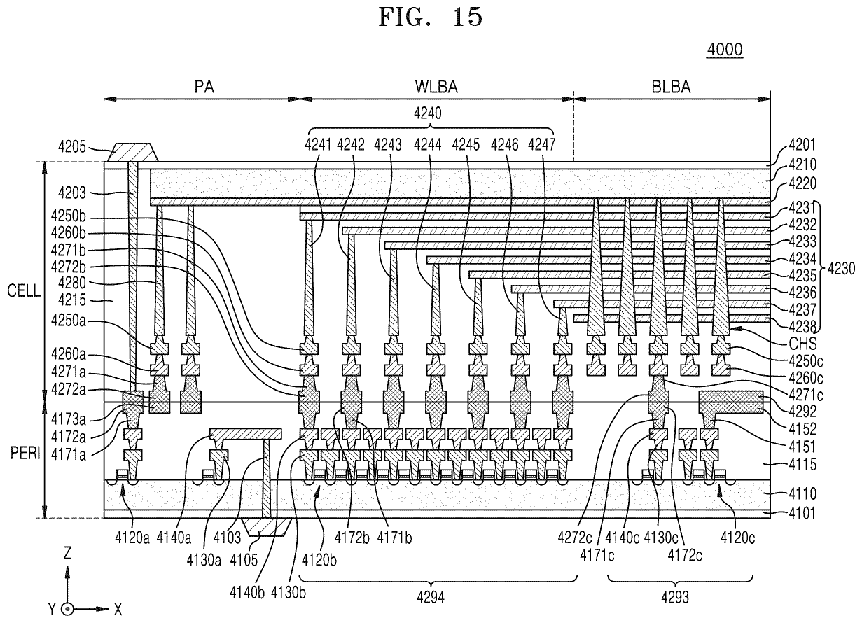

FIG. 15 is a cross-sectional view illustrating a BVNAND structure that may be applied to a storage device according to an embodiment.

Referring to FIG. 15, a memory device 4000 may have a chip-to-chip (C2C) structure. The C2C structure may refer to a structure formed by manufacturing an upper chip including a cell region CELL on a first wafer, manufacturing a lower chip including a peripheral circuit region PERI on a second wafer, different from the first wafer, and then connecting the upper chip to the lower chip by a bonding method. For example, the bonding method may refer to a method of electrically connecting a bonding metal formed on a top metal layer of the upper chip to a bonding metal formed on a top metal layer of the lower chip. For example, when the bonding metal includes copper (Cu), the bonding method may be a Cu—Cu bonding method, and the bonding metal may also include aluminum or tungsten.

Each of the peripheral circuit region PERI and the cell region CELL of the memory device 4000 may include an external pad bonding region PA, a word line bonding region WLBA, and a bit line bonding region BLBA.

The peripheral circuit region PERI may include a first substrate 4110, an interlayer insulating layer 4115, a plurality of circuit elements 4120a, 4120b, and 4120c formed on the first substrate 4110, first metal layers 4130a, 4130b, and 4130c respectively connected to the circuit elements 4120a, 4120b, and 4120c, and second metal layers 4140a, 4140b, and 4140c respectively formed on the first metal layers 4130a, 4130b, and 4130c. In an embodiment, the first metal layers 4130a, 4130b, and 4130c may include tungsten with relatively high resistance, and the second metal layers 4140a, 4140b, and 4140c may include copper with relatively low resistance.

In FIG. 15, only the first metal layers 4130a, 4130b, and 4130c and the second metal layers 4140a, 4140b, and 4140c are shown and described, but embodiments are not limited thereto, and at least one metal layer may be further formed on the second metal layers 4140a, 4140b, and 4140c. At least some of the one or more metal layers formed on top of the second metal layers 4140a, 4140b, and 4140c may include aluminum, etc., having lower resistance than that of copper forming the second metal layers 4140a, 4140b, and 4140c.

The interlayer insulating layer 4115 may be disposed on the first substrate 4110 to cover the circuit elements 4120a, 4120b, and 4120c, the first metal layers 4130a, 4130b, and 4130c, and the second metal layers 4140a, 4140b, and 4140c and may include an insulating material, such as, for example, silicon oxide, silicon nitride, etc.

Lower bonding metals 4171b and 4172b may be formed on a second metal layer 4140b of the word line bonding region WLBA. In the word line bonding region WLBA, the lower bonding metals 4171b and 4172b of the peripheral circuit region PERI may be electrically connected to upper bonding metals 4271b and 4272b of the cell region CELL by a bonding method, and the lower bonding metals 4171b and 4172b and the upper bonding metals 4271b and 4272b may include, for example, aluminum, copper, or tungsten.

The cell region CELL may provide at least one memory block. The cell region CELL may include a second substrate 4210 and a common source line 4220. On the second substrate 4210, a plurality of word lines 4231 to 4238; 4230 may be stacked in a direction (a Z-axis direction) perpendicular to an upper surface of the second substrate 4210. String select lines and a ground select line may be disposed each of above and below the word lines 4230, and the word lines 4230 may be located between the string select lines and the ground select line.

In the bit line bonding region BLBA, a channel structure CH may extend in a direction perpendicular to the upper surface of the second substrate 4210 to penetrate through the word lines 4230, the string select lines, and the ground select line. The channel structure CH may include a data storage layer, a channel layer, and a buried insulating layer, and the channel layer may be electrically connected to a first metal layer 4250c and a second metal layer 4260c. For example, the first metal layer 4250c may be a bit line contact, and the second metal layer 4260c may be a bit line. In an embodiment, the bit line 4260c may extend in a first direction (a Y-axis direction) parallel to the upper surface of the second substrate 4210.

In the embodiment shown in FIG. 15, a region in which the channel structure CH and the bit line 4260c are located may be defined as the bit line bonding region BLBA. The bit line 4260c may be electrically connected to the circuit elements 4120c that provide the page buffer 4293 in the peripheral circuit region PERI of the bit line bonding region BLBA. For example, in the peripheral circuit region PERI, the bit line 4260c may be connected to upper bonding metals 4271c and 4272c, and the upper bonding metals 4271c and 4272c may be connected to lower bonding metals 4171c and 4172c connected to the circuit elements 4120c of the page buffer 4293.

In the word line bonding region WLBA, the word lines 4230 may extend in a second direction (an X-axis direction) parallel to an upper surface of the second substrate 4210 and may be connected to a plurality of cell contact plugs 4241 to 4247; 4240. The word lines 4230 and the cell contact plugs 4240 may be connected to each other at pads provided as at least some of the word lines 4230 extend with different lengths in the second direction. A first metal layer 4250b and a second metal layer 4260b may be sequentially connected to upper portions of the cell contact plugs 4240 connected to the word lines 4230. In the word line bonding region WLBA, the cell contact plugs 4240 may be connected to the peripheral circuit region PERI through the upper bonding metals 4271b and 4272b of the cell region CELL and the lower bonding metals 4171b and 4172b of the peripheral circuit region PERI.

The cell contact plugs 4240 may be electrically connected to circuit elements 4120b that provide a row decoder 4294 in the peripheral circuit region PERI. In an embodiment, an operating voltage of the circuit elements 4120b providing the row decoder 4294 may be different from an operating voltage of the circuit elements 4120c providing a page buffer 4293. For example, the operating voltage of the circuit elements 4120c providing the page buffer 4293 may be greater than the operating voltage of the circuit elements 4120b providing the row decoder 4294.

A common source line contact plug 4280 may be located in the external pad bonding region PA. The common source line contact plug 4280 may include a conductive material, such as metal, a metal compound, or polysilicon and may be electrically connected to the common source line 4220. A first metal layer 4250a and a second metal layer 4260a may be sequentially stacked on the common source line contact plug 4280. For example, a region in which the common source line contact plug 4280, the first metal layer 4250a, and the second metal layer 4260a are located may be defined as the external pad bonding region PA.

Input/output pads 4105 and 4205 may be located in the external pad bonding region PA. Referring to FIG. 15, a lower insulating film 4101 may be formed on a lower portion of the first substrate 4110 to cover a lower surface of the first substrate 4110, and a first input/output pad 4105 may be formed on the lower insulating film 4101. The first input/output pad 4105 may be connected to at least one of the circuit elements 4120a, 4120b, and 4120c located in the peripheral circuit region PERI through the first input/output contact plug 4103 and may be separated from the first substrate 4110 by the lower insulating film 4101. In addition, a side insulating film may be located between the first input/output contact plug 4103 and the first substrate 4110 to electrically separate the first input/output contact plug 4103 from the first substrate 4110.

Referring to FIG. 15, an upper insulating film 4201 may be formed on top of the second substrate 4210 to cover an upper surface of the second substrate 4210, and a second input/output pad 4205 may be disposed on the upper insulating film 4201. The second input/output pad 4205 may be connected to at least one of the circuit elements 4120a, 4120b, and 4120c located in the peripheral circuit region PERI through the second input/output contact plug 4203.

According to an embodiment, the second substrate 4210 and the common source line 4220 may not be located in a region in which the second input/output contact plug 4203 is located. In addition, the second input/output pad 4205 may not overlap the word lines 4230 in the third direction (the Z-axis direction). Referring to FIG. 15, the second input/output contact plug 4203 may be separated from the second substrate 4210 in a direction parallel to the upper surface of the second substrate 4210 and may be connected to the second input/output pad 4205 through the interlayer insulating layer 4215 of the cell region CELL.

According to embodiments, the first input/output pad 4105 and the second input/output pad 4205 may be formed selectively. For example, the memory device 4000 may include only the first input/output pad 4105 disposed on top of the first substrate 4110 or only the second input/output pad 4205 disposed on the top of the second substrate 4210. According to another embodiment, the memory device 4000 may include both the first input/output pad 4105 and the second input/output pad 4205.

A metal pattern of the uppermost metal layer may exist as a dummy pattern in each of the external pad bonding region PA and bit line bonding region BLBA included in each of the cell region CELL and the peripheral circuit region PERI, or the uppermost metal layer may be empty.

In the memory device 4000, to correspond to an upper metal pattern 4272a formed at the uppermost metal layer of the cell region CELL in the external pad bonding region PA, a lower metal pattern 4176a having the same shape as that of the upper metal pattern 4272a of the cell region CELL may be formed on the uppermost metal layer of the peripheral circuit region PERI. The lower metal pattern 4176a formed on the uppermost metal layer of the peripheral circuit region PERI may not be connected to a separate contact in the peripheral circuit region PERI. Similarly, to correspond to a lower metal pattern formed on the uppermost metal layer of the peripheral circuit region PERI in the external pad bonding region PA, an upper metal pattern having the same shape as that of the lower metal pattern of the peripheral circuit region PERI may be formed on the upper metal layer of the cell region CELL.

Lower bonding metals 4171b and 4172b may be formed on the second metal layer 4140b of the word line bonding region WLBA. In the word line bonding region WLBA, the lower bonding metals 4171b and 4172b of the peripheral circuit region PERI may be electrically connected to the upper bonding metals 4271b and 4272b of the cell region CELL by a bonding method.

In addition, in the bit line bonding region BLBA, to correspond to a lower metal pattern 4152 formed on the uppermost metal layer of the peripheral circuit region PERI, an upper metal pattern 4292 having the same shape as that of the lower metal pattern 4152 of the peripheral circuit region PERI may be formed on the uppermost metal layer of the cell region CELL. A contact may not be formed on the upper metal pattern 4292 formed on the uppermost metal layer of the cell region CELL.

At least one of the components, elements, modules or units (collectively “components” in this paragraph) represented by a block in the drawings may be embodied as various numbers of hardware, software and/or firmware structures that execute respective functions described above, according to an exemplary embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above exemplary embodiments may be implemented in algorithms that execute on one or more processors. Furthermore, the components represented by a block or processing steps may employ any number of related art techniques for electronics configuration, signal processing and/or control, data processing and the like.

While embodiments have been described with reference to the figures, it will be understood by those of ordinary skill in the art that various changes in form and details may be made therein without departing from the spirit and scope as defined by the following claims and their equivalents.

What is claimed is:

1. A storage device comprising:
a plurality of non-volatile memory devices;
a host interface device configured to communicate with an external host device through an interface channel; and
at least one media interface device connected between the host interface device and the plurality of non-volatile memory devices, the at least one media interface device being configured to control the plurality of non-volatile memory devices,
wherein the at least one media interface device is further configured to perform an operation offloaded from the host interface device and perform serial communication with the host interface device.

2. The storage device of claim 1, wherein the at least one media interface device comprises:
a first interface circuit configured to perform the serial communication with the host interface device;
a second interface circuit configured to communicate with the plurality of non-volatile memory devices; and
a processing circuit configured to perform the operation offloaded from the host interface device.

3. The storage device of claim 2, wherein the processing circuit comprises an error correction code engine configured to generate a parity bit for write data and correct an error for read data based on the parity bit.

4. The storage device of claim 2, wherein the processing circuit comprises an advanced encryption standard engine configured to perform an encryption operation on write data based on an encryption key and perform a decryption operation on read data.

5. The storage device of claim 2, wherein the processing circuit comprises a flash translation layer circuit configured to perform at least one of address mapping, wear-leveling, and garbage collection.

6. The storage device of claim 2, wherein the media interface device further comprises a buffer memory configured to temporarily store data.

7. The storage device of claim 2, wherein the first interface circuit is further configured to communicate with the plurality of non-volatile memory devices through a frequency boosting interface method.

8. The storage device of claim 1, wherein the at least one media interface device and the plurality of non-volatile memory devices are configured as chiplets included in a single package.

9. The storage device of claim 1, wherein the at least one media interface device and the host interface device are configured as chiplets included in a single package.

10. A system comprising:
a plurality of non-volatile memory devices; and
a media interface device comprising:
a first interface circuit configured to connect to an external host interface device to operate as a storage device;
a second interface circuit configured to connect to the plurality of non-volatile memory devices; and
a processing circuit configured to perform an operation offloaded from the host interface device,
wherein the first interface circuit is further configured to perform serial communication with the host interface device.

11. The system of claim 10, wherein the processing circuit comprises an error correction code engine configured to generate a parity bit for write data and correct an error for read data based on the parity bit.

12. The system of claim 10, wherein the processing circuit comprises an advanced encryption standard engine configured to perform an encryption operation on write data based on an encryption key and perform a decryption operation on read data.

13. The system of claim 10, wherein the processing circuit comprises a flash translation layer circuit configured to perform at least one of address mapping, wear-leveling, and garbage collection.

14. The system of claim 10, wherein the media interface device further comprises a buffer memory configured to temporarily store data.

15. The system of claim 10, wherein the first interface circuit is further configured to communicate with the plurality of non-volatile memory devices through a frequency boosting interface method.

16. An operating method of a media interface device connected between a host interface device configured to communicate with an external host device and a plurality of non-volatile memory devices and configured to control the plurality of non-volatile memory devices, the operating method comprising:
receiving, from the host interface device, a first command in which a plurality of host commands of the external host device is serialized;
deserializing the first command to generate a plurality of second commands;
performing an operation offloaded from the host interface device on the plurality of second commands to generate a plurality of third commands; and
transmitting the plurality of third commands to the plurality of non-volatile memory devices, respectively.

17. The operating method of claim 16, wherein the generating of the plurality of third commands comprises generating a parity bit for data corresponding to the second command by an error correction code engine.

18. The operating method of claim 16, wherein the generating of the plurality of third commands comprises performing, by an advanced encryption standard engine, an encryption operation on data corresponding to the second command using an encryption key.

19. The operating method of claim 16, wherein the media interface device and the plurality of non-volatile memory devices are configured as chiplets included in a single package, and
wherein the single package is configured to be combined with the host interface device which is separately packaged from the single package.

20. The operating method of claim 16, wherein the media interface device and the host interface device are configured as chiplets included in a single package, and
wherein the single package is configured to be combined with the plurality of non-volatile memory devices which are separately packaged from the single package.
